(19) United States
(12) Patent Application Publication
(10) Pub. No.: US 2004/0252983 A1
(43) Pub. Date: Dec. 16, 2004

(54) Method and apparatus for reproducing AV data in an interactive mode, and information storage medium therefor

(75) Inventors: Kil-soo Jung, Taean-eup (KR); Sung-wook Park, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/770,128

(22) Filed: Feb. 3, 2004

Related U.S. Application Data
(63) Continuation-in-part of application No. 10/685,396, filed on Oct. 16, 2003, now abandoned.

(30) Foreign Application Priority Data
Feb. 4, 2003 (KR) 2003-6725
Nov. 14, 2003 (KR) 2003-80543

(51) Int. Cl. H04N 5/85

(52) U.S. Cl. 386/125

(57) ABSTRACT

An information storage medium stores audio/video (AV) data; and interactive data for reproducing the AV data in an interactive mode. The interactive data includes a plurality of ENAV units, each of which is smaller than a predetermined size. When predetermined AV data is reproduced, a buffer is emptied when an ENAV is to be changed, and the ENAV unit to be changed is read in advance such that the buffer is managed to allow seamless reproduction of AV data.

### CROSS-REFERENCE TO RELATED APPLICATIONS

This application is a continuation-in-part of U.S. patent application Ser. No. 10/685,396, filed Oct. 16, 2003, the disclosure of which is incorporated herein by reference. This application claims the benefit from Korean Patent Application No. 2003-6725, filed on Feb. 4, 2003, in the Korean Intellectual Property Office, and Korean Patent Application No. 2003-80543, filed on Nov. 14, 2003 in the Korean Intellectual Property Office, the contents of which are incorporated herein by reference in their entirety.

### BACKGROUND OF THE INVENTION

1. Field of the Invention

The present invention relates to a method for reproducing audio/video (AV) data in an interactive mode, and more particularly, to a method and apparatus for seamlessly reproducing AV data by appropriately buffering interactive data for reproducing AV data in an interactive mode, and an information storage medium therefor.

2. Description of the Related Art

Interactive DVDs that can be reproduced in a personal computer (PC) are on the market. An interactive DVD means a DVD in which interactive data, for example, markup documents, are recoded in addition to recorded DVD-Video data. Interactive DVDs can be reproduced in either of two modes. One is video mode in which only DVD-Video data is reproduced as with an ordinary DVD, and the other is interactive mode in which DVD-Video data is reproduced together with a markup document and is displayed through a display window of the markup document. If the interactive mode is selected by a user, a web browser embedded in the PC parses and displays a markup document recorded on the interactive DVD. In the display window defined by the markup document, DVD-Video data selected by the user is displayed. For example, if the DVD-Video data is a film, the film is reproduced in the display window of the markup document and in the remaining part the script, synopsis, photos of actors, and other related additional information of the film can be displayed. Additional information includes image files and/or text files.

FIG. 1 is a diagram of the physical structure of a track of a conventional interactive DVD. Referring to FIG. 1, in the track of the interactive DVD, DVD-Video data (i.e., AV data) is recorded as MPEG bitstreams, and interactive data including a plurality of markup documents or markup resources containing a variety of image files and graphic files that are embedded into markup documents is recorded. FIGS. 2A and 2B are reference diagrams for explaining a break that can occur in a reproducing process of the interactive DVD of FIG. 1. Referring to FIGS. 2A and 2B, the state of an AV buffer in which DVD-Video data is buffered, and the state of an interactive buffer in which interactive data is buffered are shown. Referring to FIGS. 1 through 2B, a process of AV data being buffered in the buffer and then displayed will now be explained. A pickup apparatus searches for and reads STARTUP.HTM and buffers the file in the buffer. The loaded STARTUP.HTM is activated. At the same time, (1) AV data selected by a user is buffered and then displaying of (1) AV data begins. Then, (2) AV data is buffered and displaying of (2) AV data begins. If buffering of (2) AV data finishes, the pickup apparatus jumps to a location in which (3) AV data is recorded and begins buffering. If the user requests (4) A.HTM, the pickup apparatus stops buffering the (3) AV data and searches for the (4) A.HTM and buffers the data for the (4) A.HTM.

During this time, the (3) AV data is continuously displayed. Accordingly, the amount of data that can be buffered and displayed rapidly decreases. After the (4) A.HTM is activated and buffering of the (3) AV data finishes, (5) AV data is buffered. If buffering of the (5) AV data finishes, the pickup apparatus jumps to a location in which (6) AV data is recorded. In this case, data being buffered may be exhausted. That is, in the conventional interactive DVD, when a DVD-Video screen and a markup screen should be synchronized with each other before being displayed (for example, a case in which when a predetermined actor appears, a profile of the actor is displayed), the pickup apparatus has to stop buffering AV data and search for and read a markup document corresponding a DVD-Video screen, and buffer the markup document. Accordingly, a break in displaying DVD-Video scenes may occur.

### SUMMARY OF THE INVENTION

An aspect of the present invention provides a method and apparatus by which when audio/video (AV) data is reproduced in an interactive mode, buffering of interactive data is smoothly performed so that a break during reproduction of AV data does not occur, and an information storage medium therefor.

Additional aspects and/or advantages of the invention will be set forth in part in the description which follows and, in part, will be obvious from the description, or may be learned by practice of the invention.

According to an aspect of the present invention, an information storage medium stores audio/video (AV) data and interactive data for use by a recording and/or reproducing apparatus to reproduce the AV data in an interactive mode, wherein the interactive data includes a plurality of ENAV units which are smaller than a predetermined size.

According to an aspect of the invention, the interactive data includes link information regarding the relation between the AV data and the ENAV units.

According to an aspect of the invention, the link information is described by using the structure of the AV data.

According to an aspect of the invention, the link information reproducing time information of the AV data or information regarding at a point where the AV data is reproduced.

According to an aspect of the invention, the ENAV unit has at least one ENAV page and in each ENAV page, synchronization information indicating the time for which to display the ENAV page is recorded.

According to an aspect of the invention, the interactive data includes a markup document and markup resources linked to the markup document.

According to an aspect of the invention, the link information is included in a startup file that is required to be interpreted before the ENAV page is output.

According to an aspect of the invention, markup documents corresponding to the ENAV pages specify synchronization information.

According to an aspect of the invention, the link information is included in a schedule file that describes schedule information regarding an instant of time when the ENAV unit is to be read into a buffer memory of a reproducing apparatus and an instant of time when the ENAV unit is deleted from the buffer memory.

According to an aspect of the invention, the AV data is DVD-Video data and the link information and the synchronization information are described by using a presentation time stamp of the DVD-Video data.

According to another aspect of the present invention, an information storage medium stores audio/video (AV) data and interactive data for use by a recording and/or reproducing apparatus to reproduce the AV data in an interactive mode, wherein the interactive data comprises a plurality of ENAV units, each of the ENAV units is smaller than a predetermined size, and the start page of each of the ENAV units is stored as a predetermined start file name.

According to an aspect of the invention, each of the ENAV units has at least one ENAV page and the start page itself is an ENAV page.

According to still another aspect of the present invention, an information storage medium stores audio/video (AV) data and interactive data for use by a recording and/or reproducing apparatus to reproduce the AV data in an interactive mode, wherein the interactive data includes at least one ENAV page in which is recorded control command information for an ENAV buffer of the recording and/or reproducing apparatus which buffers the ENAV page.

According to an aspect of the invention, the control command information commands the data stored in the ENAV buffer to be discarded.

According to an aspect of the invention, the interactive data is divided into a plurality of ENAV units containing the ENAV pages.

According to an aspect of the invention, the control command information commands a buffered ENAV unit stored in the ENAV buffer to be discarded and a next ENAV unit to be read in.

According to yet still another aspect of the present invention, an apparatus for reproducing audio/video (AV) data in an interactive mode includes an ENAV buffer which buffers interactive data which comprises a plurality of ENAV units, each of the ENAV units being smaller than a predetermined size and are for reproducing the AV data in the interactive mode, an ENAV buffer manager which controls the ENAV buffer so that the interactive data is read in and discarded in units of ENAV units, and a reproducing unit that reproduces the AV data in the interactive mode using the interactive data from the ENAV buffer.

According to an aspect of the invention, by referring to link information between the AV data and the ENAV units, which is described by using a structure of the AV data, the ENAV buffer manager controls the ENAV buffer so that an ENAV unit is read in before the AV data corresponding to the ENAV unit is displayed.

According to an aspect of the invention, by referring to link information between the AV data and the ENAV units, which is described by using the reproducing time information of the AV data, the ENAV buffer manager controls the ENAV buffer so that an ENAV unit is read in before AV data corresponding to the ENAV unit is displayed.

According to an aspect of the invention, by referring to synchronization information recorded in a markup document corresponding to each of the ENAV pages, the ENAV buffer manager controls the ENAV buffer so that an ENAV unit corresponding to the synchronization information is read in.

According to an aspect of the invention, by referring to the synchronization information and the link information between the AV data and the ENAV units, the ENAV buffer manager controls the ENAV buffer so that a corresponding ENAV unit is read in.

According to a further aspect of the present invention, an apparatus for reproducing audio/video (AV) data in an interactive mode includes an ENAV buffer which buffers interactive data comprising a plurality of ENAV units, each of the ENAV units being smaller than a predetermined size and are for reproducing the AV data in the interactive mode, an ENAV buffer manager which controls the ENAV buffer so that if a start page having a predetermined file name is found, an ENAV unit corresponding to the start page is read in, and a reproducing unit that reproduces the AV data in the interactive mode using the interactive data from the ENAV buffer.

According to an aspect of the invention, the ENAV unit has at least one ENAV page and the start page itself is an ENAV page.

According to an additional aspect of the present invention, a method of reproducing audio/video (AV) data in an interactive mode includes buffering interactive data for reproducing the AV data in an interactive mode, by reading in and discarding interactive data in units of ENAV units, each of the ENAV units being smaller than a predetermined size; and reproducing the AV data in an interactive mode by using the buffered interactive data.

According to an aspect of the invention, the buffering the interactive data includes reading an ENAV unit before the AV data corresponding to the ENAV unit is displayed by referring to link information between the AV data and the ENAV units, where the link information is described using a structure of the AV data.

According to an aspect of the invention, the buffering the interactive data includes reading an ENAV unit before AV data corresponding to the ENAV unit is displayed by referring to link information between the AV data and the ENAV units, where the link information is described by using the reproducing time information of the AV data.

According to an aspect of the invention, the buffering the interactive data includes reading an ENAV unit corresponding to synchronization information by referring to the synchronization information recorded in a markup document corresponding to each of the ENAV pages.

According to an aspect of the invention, the buffering the interactive data includes reading a corresponding ENAV unit by referring to the synchronization information and the link information between the AV data and the ENAV units.

### BRIEF DESCRIPTION OF THE DRAWINGS

The above objects and/or other aspects and advantages of the invention will become more apparent and more readily appreciated from the following description of embodiments taken in conjunction with the accompanying drawings in which:

FIG. 1 is a diagram of the physical structure of a track of a conventional interactive DVD;

FIGS. 2A and 2B are reference diagrams for explaining a break that can occur in a process of reproducing the interactive DVD of FIG. 1;

FIG. 3 is a diagram of a reproducing system according to an embodiment of the present invention;

FIG. 4 is a block diagram of a reproducing apparatus according to an embodiment of the present invention;

FIG. 5 is a block diagram showing an embodiment of an ENAV buffer of FIG. 4 and the relation between the ENAV buffer and an EVAV buffer manager;

FIG. 6 is a block diagram illustrating the relation between an AV buffer and an AV buffer manager;

FIGS. 7A through 7D illustrate a buffer control method according to an embodiment of the present invention;

FIG. 8 illustrates a data structure of a disc to which an interactive data area is allocated, according to an embodiment of the present invention;

FIG. 9 illustrates a directory of a disc on which interactive data is recorded, according to an embodiment of the present invention;

FIG. 10 illustrates a file structure of an ENAV unit, according to an embodiment of the present invention;

FIGS. 11 and 12 illustrate examples of link information for executing the method of FIGS. 7A through 7D, according to embodiments of the present invention;

FIG. 13 is an example of synchronization information for controlling the method of FIGS. 7A through 7D, according to an embodiment of the present invention;

FIG. 14 is a reference diagram illustrating the method of FIGS. 7A through 7D, according to another embodiment of the present invention;

FIG. 15 is a reference diagram illustrating the method of FIGS. 7A through 7D, according to yet another embodiment of the present invention; and

FIGS. 16A and 16B illustrate the amount of AV data read so as to read an ENAV unit and a size of an AV buffer for buffering the AV data.

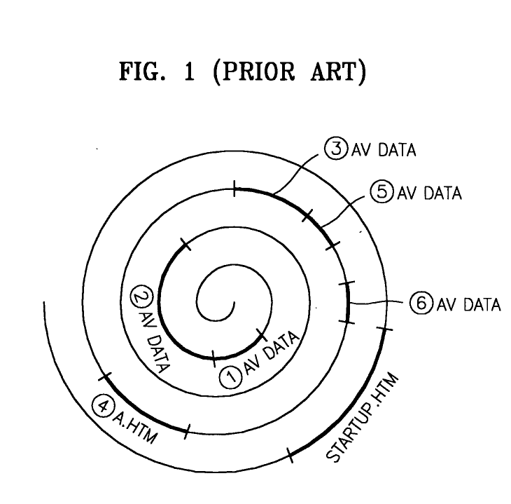

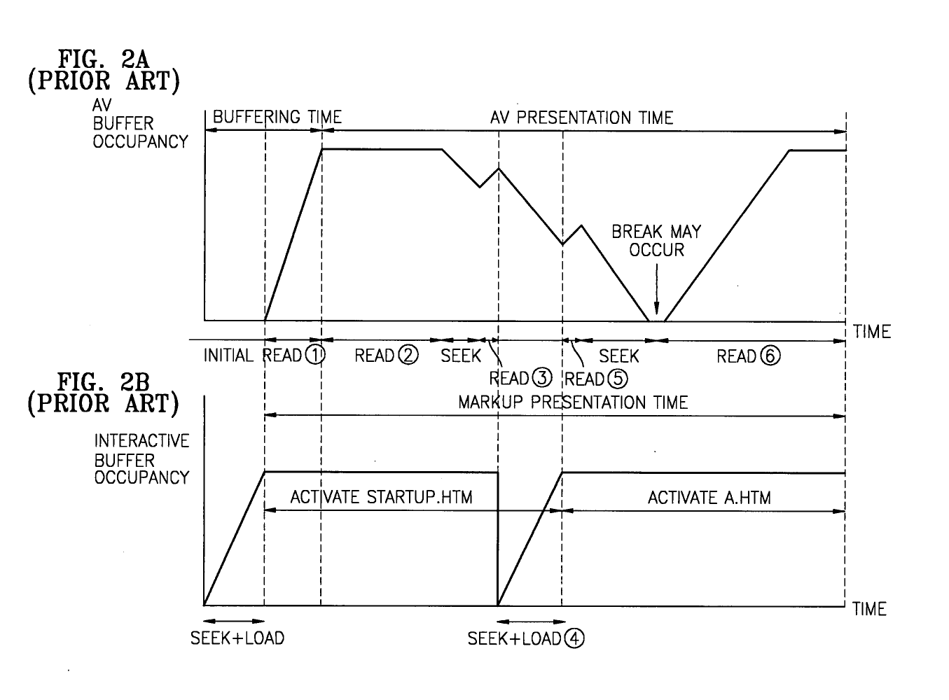

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

In the present invention, interactive data indicates data that are needed in reproducing audio/video (AV) data in an interactive mode. The interactive mode indicates a mode in which not only an AV screen obtained from AV data is displayed, but also a screen is displayed in which additional information or through which interaction with a user is enabled. For example, the interactive data indicates not only markup documents, but also markup resources containing files that are embedded into or linked to a markup document. In addition to HTML, “˜.HTM” also represents documents written in markup languages such as XML and SGML that are displayed in an interactive mode. Moreover, it is understood that other languages can be implicated, such as JAVASCRIPT, and other applications can be implemented using the language, such as through applets

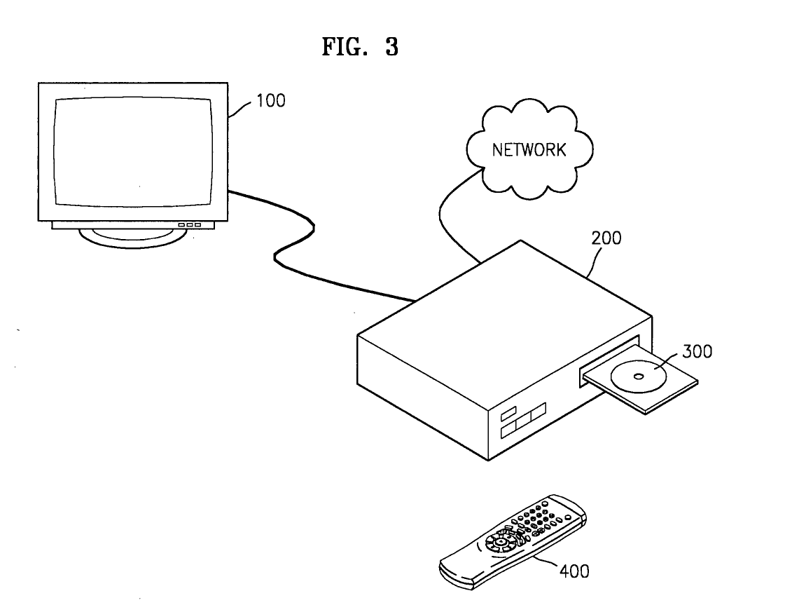

FIG. 3 is a diagram of a recording and/or reproducing system according to an embodiment of the present invention. Referring to FIG. 3, the recording and/or reproducing system comprises a digital versatile disk (DVD) 300, which is an information storage medium according to an embodiment of the present invention, a reproducing apparatus 200, a TV 100, which is a display apparatus according to an aspect of the present embodiment, and a remote controller 400 as a user input apparatus. It is understood that the TV 100 could instead be another type of display unit, such as an LCD or a PDP, a flat panel display, or other types of display units through which visual images are displayed. It is further understood that the user input apparatus could include a keyboard or other computer input device, such as a stylus or touch screen, instead of or in addition to the remote controller 400. Lastly, it is also understood that the information storage medium could be other than a DVD, such as next generation DVD including Blu-ray discs or Advanced Optical Discs (AODs), a CD, magnetic media, and that the information storage medium could be writable as well as read only.

According to an embodiment of the invention, the DVD-Video data includes audio/video (AV) data and interactive data for reproducing the DVD-Video data in an interactive mode. In the present embodiment, the interactive data is implemented as markup documents written in markup languages, and markup resources linked to the markup documents. According to an aspect of the invention, the interactive data is divided into a plurality of ENAV units. Each of the ENAV units is equal to or less than a predetermined size. However, it is understood that the plurality of ENAV units could also be of other sizes.

An ENAV unit is a unit for buffering according to an aspect of the present invention. That is, the ENAV unit is one of a plurality of units obtained by dividing the interactive data into units which are equal to or less than the predetermined size in order to buffer the interactive data. In an aspect of the invention, the ENAV unit contains at least one ENAV page. The ENAV page may be implemented as a markup document, or a markup document and at least one markup resource linked to the markup document. Specifically, in terms of what is displayed, the ENAV page indicates a set of data used to display an interactive screen in which a markup document and markup resources linked to the markup document (such as an image, animation, asynchronous audio data, and moving pictures) are all embedded and displayed. However, it is understood that the markup document need not display data beyond defining an AV screen size or location. More detailed data structures of the DVD 300 will be explained later referring to each embodiment.

According to an aspect of the invention, the remote controller 400 receives a control command from the user and transmits the command to the recording and/or reproducing apparatus 200. The reproducing recording and/or apparatus 200 has a DVD drive for reading data recorded on the DVD 300. If the DVD 300 is placed on the DVD drive and the user selects the interactive mode, the recording and/or reproducing apparatus 200 buffers the interactive data in units of ENAV units in a predetermined order. Using the buffered interactive data, the recording and/or reproducing apparatus 200 reproduces corresponding AV data in the interactive mode and transmits the reproduced data to the TV 100. The reproduced data is displayed on the TV 100 as an interactive screen and an AV screen embedded in the interactive screen obtained from the interactive data.

Interactive mode indicates a mode in which the AV data is displayed together with interactive data. That is, in an aspect of the present embodiment, the AV data is displayed in a display window defined in a markup document such that the AV screen is displayed embedded in the interactive screen. According to an aspect of the invention, the AV screen indicates a screen displayed on the display apparatus by reproducing AV data, and the interactive screen indicates a screen displayed on the display apparatus after the markup document and markup resources are parsed.

Additionally, a video mode is a mode in which the AV data is reproduced in the same manner as DVD-Video as understood in the art, and a detailed description of which is not provided. Specifically, only the AV screen obtained by reproducing the corresponding AV data is displayed. In the present embodiment, the recording and/reproducing apparatus 200 supports both the interactive mode and the video mode. In addition, the recording and/reproducing apparatus 200 can access the Internet and transmit data separately or according to the ENAV units of the DVD 300.

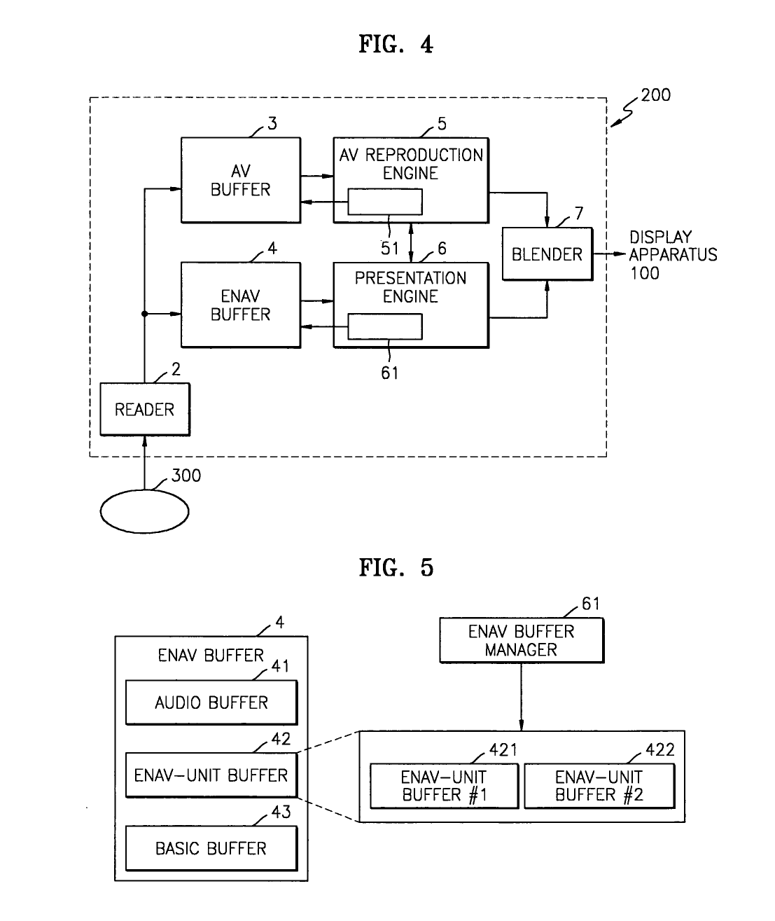

FIG. 4 is a block diagram of a recording and/or reproducing apparatus according to an embodiment of the present invention. Referring to FIG. 4, the recording and/or reproducing apparatus is an apparatus which supports the interactive mode in which an AV stream, obtained by decoding the AV data recorded on the DVD 300, is output through a display window defined by a markup document. The recording and/or reproducing apparatus comprises a reader 2, an AV buffer 3, an ENAV buffer 4, an AV reproducing engine 5, a presentation engine 6 and a blender 7. An ENAV buffer manager 61 is installed in the presentation engine 6. For the sake of simplicity, only reproducing aspects of the recording and/or reproducing apparatus shown in FIG. 3 will be referred to below. However, it is understood that a recording operation could be performed using the apparatus to create the DVD 300 using the recording and/or reproducing apparatus shown in FIGS. 3 and 4.

The reader 2 reads the AV data and the interactive data recorded on the DVD 300. The ENAV buffer 4 is logically or physically divided into a plurality of parts so that the ENAV buffer 4 can buffer the interactive data in units of ENAV units. Each of the ENAV units is equal to or less than a predetermined size. Buffering data in units of ENAV units allows the interactive data to be read and discarded in units of the ENAV units. One of the reasons why the ENAV buffer 4 is divided into at least two parts is to enable a read operation for reading interactive data in units of ENAV units into part of the ENAV buffer 4 and at least part of a discard operation for discarding data stored in the other part to be carried out at the same time. Another reason is to avoid the difficulties of dynamic buffer management for a single part buffer, in which part of data already stored in the buffer should be discarded in order to buffer new data, and to manage the buffer more conveniently and efficiently. However, it is understood such a single part buffer could be implemented using the dynamic buffer management according to an aspect of the invention.

The presentation engine 6 is an interpretation engine which parses markup languages and client parsing program languages. Examples of such languages include, but are not limited to, JAVASCRIPT and JAVA. In addition, the presentation engine 6 has a decoder for decoding markup resources such that markup files having a variety of formats can be opened. In the interactive mode, the presentation engine 6 fetches the markup document (and markup resources) from the ENAV buffer 4, parses the fetched markup document, and confirms location of a display window in which is to be displayed the AV data stream output from the reproducing engine 5. The presentation engine 6 also detects that portion of the AV data being reproduced by the AV reproduction engine 5. The blender 7 blends the AV data stream with the display window so that the AV data stream is displayed in the display window defined by the markup document. Specifically, the AV screen is embedded in the interactive screen. Then, the blender 7 outputs the result to the TV 100.

In particular, according to an aspect of the present invention, before the AV data corresponding to ENAV units is displayed on the display apparatus 100, the ENAV buffer manager 61 controls the ENAV buffer 4 so that, for example, predetermined ENAV units are read in a predetermined order. As another example, the ENAV buffer manager 61 controls the ENAV buffer 4 so that, before the AV data is displayed on the display apparatus 100, the ENAV units corresponding to the AV data is read by referring to link information described by using the DVD-Video data structure. As still another example, the ENAV buffer manager 61 controls the ENAV buffer 61 so that, before the AV data is displayed on the display apparatus 100, the ENAV units corresponding to the AV data is read by referring to link information described by using reproducing time information of the AV data. Thus, the ENAV buffer manager 61 detects that portion of the AV data being reproduced in the AV reproduction engine 5. The ENAV buffer manager 61 buffers required interactive data before the AV data is displayed on the display apparatus 100 such that the ENAV buffer manager 61 can prevent a break in the display of the AV data that otherwise occurs when the buffering of the AV data stops in order to read the interactive data which should be displayed together with corresponding AV data.

FIG. 5 is a diagram showing an embodiment of the ENAV buffer 4 of FIG. 4 and the relation between the ENAV buffer 4 and the EVAV buffer manager 61. Referring to FIG. 5, the ENAV buffer 4 comprises an audio buffer 41, an ENAV-unit buffer 42, and a basic buffer 43. The audio buffer 41 buffers audio data that are reproduced in synchronization with the AV data. For example, the audio data might be a speech (audio data) or commentary of a producer of a film (AV data). The basic buffer 43 buffers data such as font data or image data to be used for rendering text referred to by a markup resource when such data needs to be buffered using the ENAV buffer 4 regardless of link information with AV data.

The ENAV-unit buffer 42 buffers ENAV pages in units of ENAV units. An ENAV unit is a set of data which should be read in at the same time in order to reproduce the AV data seamlessly, and contains at least one ENAV page. If the size of the ENAV-unit buffer 42 is generally greater than the size of interactive data recorded on the DVD 300, there is no special need to manage the buffering of interactive data because all the interactive data can be read before reproduction of the AV data begins. However, the greater the size of the buffer 42, the bigger the size of the entire system should be and the higher the price of the system. Accordingly, the ENAV-unit buffer 42 generally has a predetermined size less than the entire size of the interactive data. Particularly, the ENAV-unit buffer 42 according to an aspect of the present embodiment is logically or physically divided into two parts, ENAV-unit buffer #1 421 and ENAV-unit buffer #2 422. However, it is understood that more ENAV-unit buffers can be used, that the division can be logical and/or physical, and that the size of the buffer can be larger than the interactive data according to other aspects of the invention.

In the shown embodiment, when the AV data is reproduced, the ENAV buffer manager 61 senses a time when an ENAV unit corresponding to the AV data is to be replaced with another ENAV unit, empties either the ENAV-unit buffer #1 421 or the ENAV-unit buffer #2 422, and buffers the next ENAV unit in the emptied buffer. That is, while an ENAV unit stored in the ENAV-unit buffer #1 421 is read, another ENAV unit stored in the ENAV-unit buffer #2 422 is discarded, and still another ENAV unit is read into the ENAV-unit buffer #2 422. Again, while the ENAV unit newly stored in the ENAV-unit buffer #2 422 is read, the ENAV unit stored in the ENAV-unit buffer #1 421 is discarded and then another ENAV unit is read into the ENAV-unit buffer #1 421. In the shown embodiment, operations of the two ENAV-unit buffers #1 421 and #2 422 are described but these operations can be performed by more than two ENAV-unit buffers.

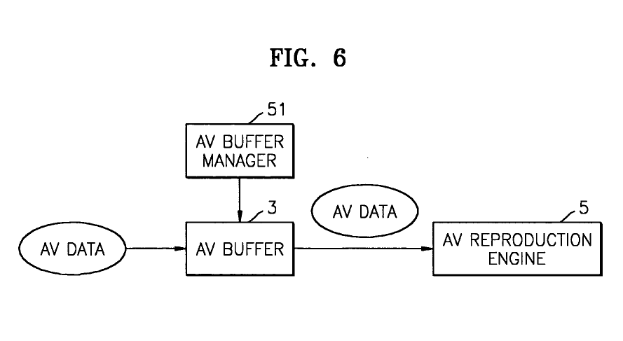

FIG. 6 shows the relation between the AV buffer 3 and the AV buffer manager 51 of FIG. 4. Referring to FIG. 6, the AV buffer manager 51 controls the AV buffer 3 to buffer AV data. The AV data buffered by the AV buffer 3 is output to the AV reproducing engine 5.

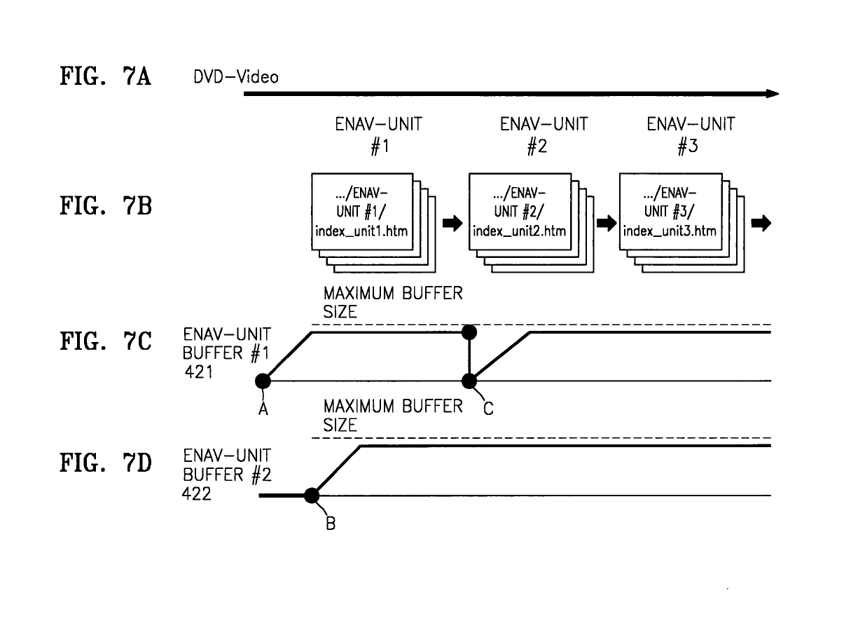

FIGS. 7A through 7D illustrate a buffer control method according to an embodiment of the present invention. Referring to FIGS. 7A through 7D, the interactive data is divided into a plurality of ENAV units, #1, #2, #3, . . . . Each of the ENAV units contains at least one ENAV page. A markup resource is an element constituting the ENAV page. According to an aspect of the present invention, the ENAV page includes a markup document index_unit #.htm.

At time A, the ENAV buffer manager 61 reads ENAV unit #1 into the ENAV-unit buffer #1 421. At time B, the ENAV buffer manager 61 reads ENAV unit #2 into the ENAV-unit buffer #2 422. Time A and time B may be determined in a variety of ways, and time A does not necessarily precede time B in all aspects of the invention. The ENAV buffer manager 61 senses the change of an ENAV unit at time C, and discards ENAV unit #1 stored in the ENAV-unit buffer #1 421, and begins to read in ENAV unit #3 to the ENAV-unit buffer #1 421.

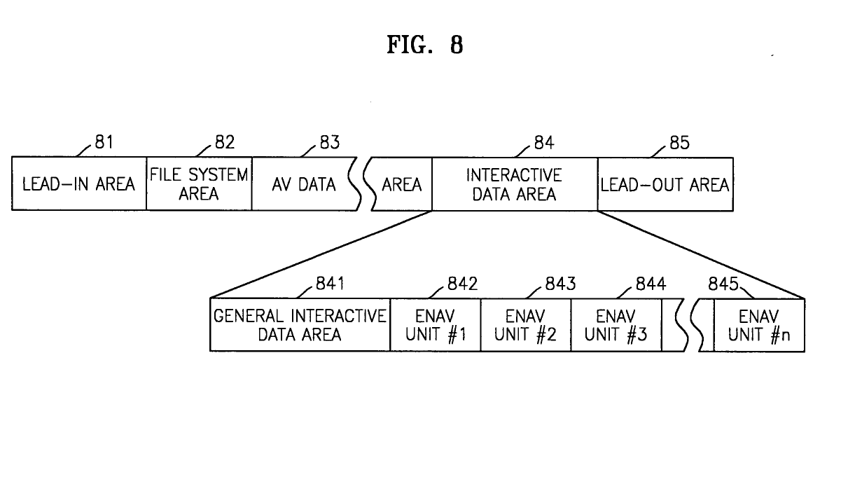

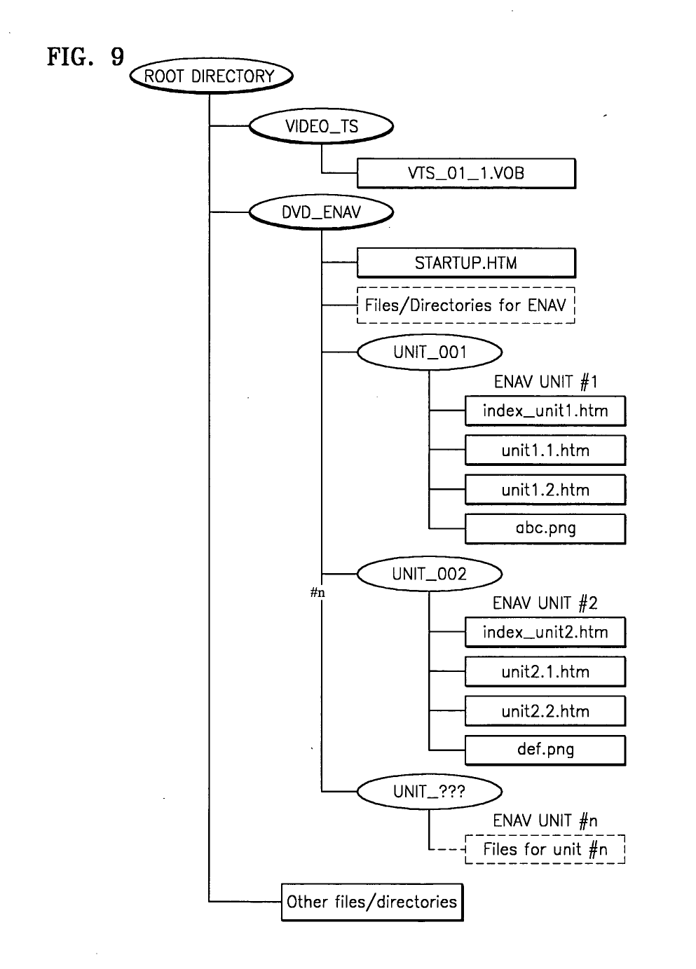

FIG. 8 illustrates a data structure of a disc, such as the DVD 300 of FIG. 3, to which an interactive data area 84 is allocated according to an embodiment of the present invention. Referring to FIG. 8, the interactive data area 84 includes a general interactive data area 841, an ENAV unit #1 842, an ENAV unit #2 843, an ENAV unit #3 844, . . . , and an ENAV unit #n 845. When an ENAV unit is read, files of the read ENAV unit are preferably continuously recorded in the same area to minimize references to a file system.

FIG. 9 illustrates a directory of a disc, such as the DVD 300 of FIG. 3, on which the interactive data is recorded according to an embodiment of the present invention. Referring to FIG. 9, an ENAV unit includes standard directory names to make file management convenient. For instance, an ENAV unit #1 includes files index_unit1.htm, unit2_{—}1.htm, and unit1_{—}2htm, and an ENAV unit #2 includes files index_unit2.htm, unit2_{—}1.htm, and unit2_{—}2.htm. However, it is understood that other names can be used.

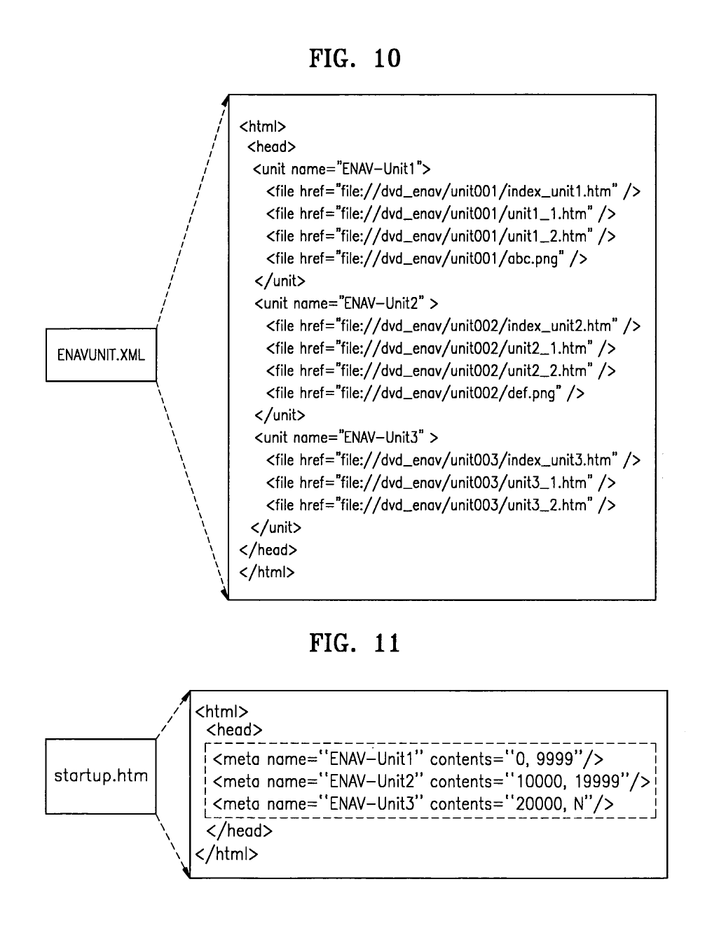

Referring to the embodiment shown in FIG. 10, files belonging to an ENAV unit are described and managed as descriptive files for the convenience of file management.

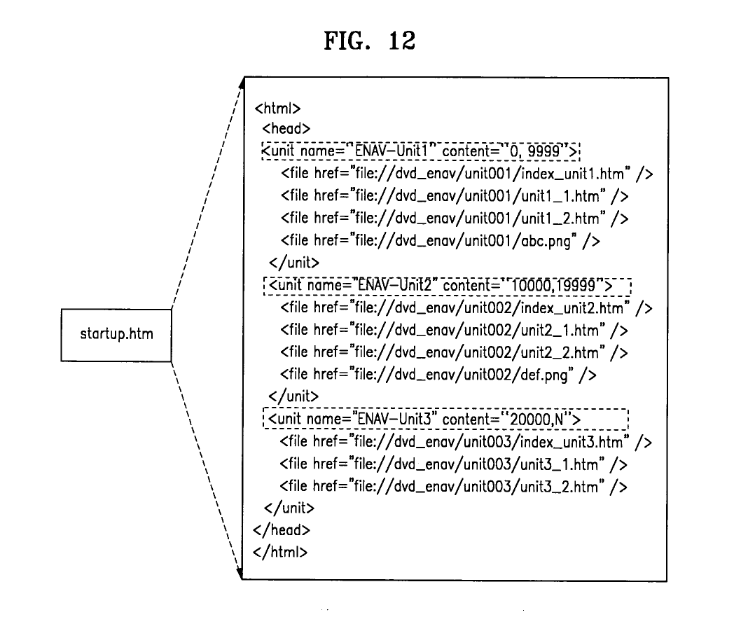

FIGS. 11 and 12 illustrate examples of link information for use in executing the method of FIGS. 7A through 7D, according to embodiments of the present invention. A startup file startup.htm of FIG. 11 or a schedule file startup.htm of FIG. 12 is not displayed on the display apparatus (i.e., the TV 100), but performs a function to provide a variety of parameter values. Examples of the parameter values include, but are not limited to, a size of a screen, a color of a screen, etc. In the startup file or schedule file startup.htm, a box marked by dotted lines indicates link information according to an aspect of the present embodiment. The link information is implemented as information obtained by mapping a presentation time stamp (PTS) that is the reproducing time information of DVD-Video data corresponding to an ENAV unit. ENAV unit #1 corresponds to PTS 0-9999, ENAV unit #2 corresponds to PTS 10000-19999 of DVD-Video, and ENAV unit #3 corresponds to PTS 2000-N of DVD-Video. Accordingly, it is shown that ENAV unit #1, that is, ENAV pages corresponding to PTS 0-9999, is first read into the ENAV-unit buffer #1 421, and ENAV unit #2, that is, ENAV pages corresponding to PTS 10000-19999, is first read into the ENAV-unit buffer #2 422, and ENAV unit #3, that is, ENAV pages corresponding to PTS 20000-N, is read into the ENAV-unit buffer #1 421. Thus, in the startup file startup.htm, link information on ENAV units #1, #2, and #3 of DVD-Video, which are each smaller than the size of each unit of the ENAV-unit buffer 42, can be ordered using a PTS that is reproducing time information of the DVD-Video.

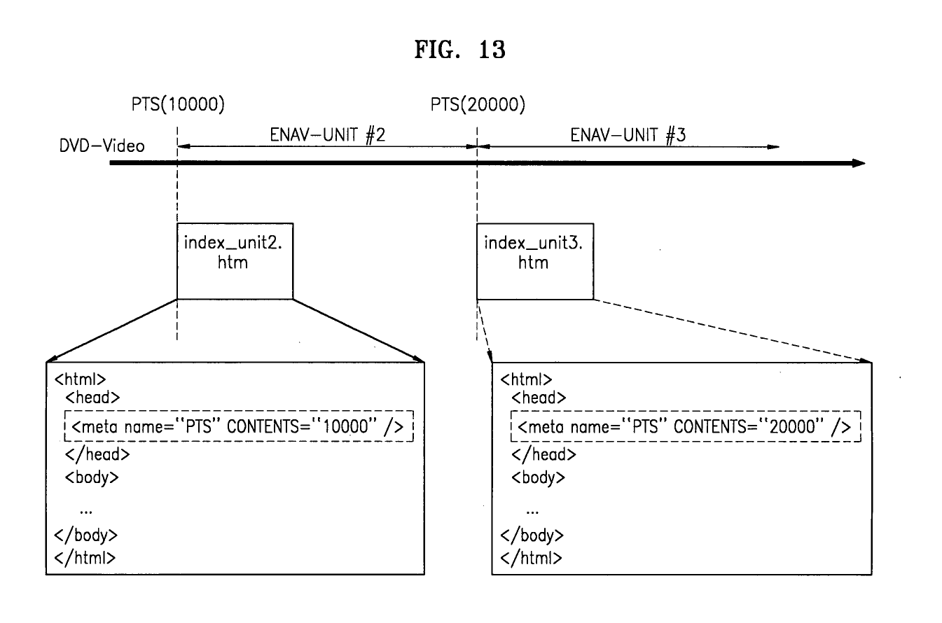

FIG. 13 is an example of synchronization information for use in executing the method of FIGS. 7A through 7D, according to an embodiment of the present invention. Referring to FIG. 13, a box marked by dotted lines of index_unit2.htm indicates synchronization information according to an aspect of the present embodiment. If the start page index_unit2.htm of ENAV unit #2 is called by navigation of the user according to an arbitrary route, the presentation engine 6 parses index_unit2.htm and finds that the synchronization information (i.e., a time when the document should be displayed) is PTS 10000 of the DVD-Video. Specifically, the presentation engine 6 realizes that ENAV unit #1 is changed by ENAV unit #2 through the link information obtained from the startup file startup.htm, as described above referring to FIGS. 7A through 7D. Then, the ENAV buffer manager 61 sends a control command that ENAV-unit buffer #1 421 that is storing ENAV unit #1 be emptied, and then a control command that ENAV unit #2 be read in. Then, if the start page index_unit3.htm of ENAV unit #3 is called after ENAV unit #2 has been completely reproduced, the presentation engine 6 parses index_unit3.htm and realizes that synchronization information (i.e., a, time when the document should be displayed) is PTS 20000 of DVD-Video, and that ENAV unit #2 is changed by ENAV unit #3, through the link information obtained from the startup file startup.htm, as described above referring to FIGS. 7A through 7D. Then, the ENAV buffer manager 61 sends a control command that ENAV-unit buffer #2 422 then storing the ENAV unit #2 to be emptied, and then a control command that the ENAV unit #3 be read in. The control command for emptying the buffer and the control command for reading the ENAV unit in may be indicated as 1) and 2) below, respectively:

1) navigator.Discard(“ENAV_Unit N”)

2) navigator.Preload(“ENAV_Unit N”)

In the above control commands, “ENAV_Unit” may be a name indicating a set of included files or may be all included files.

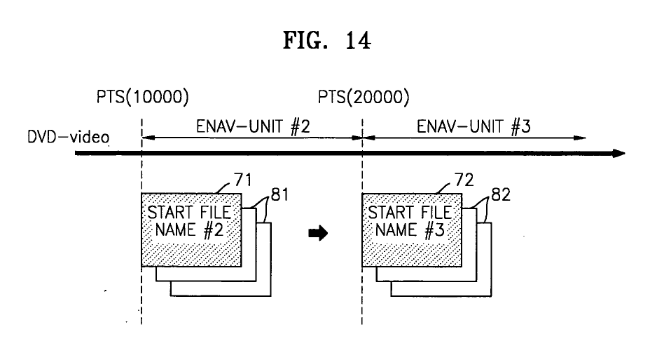

FIG. 14 is a reference diagram illustrating the method of FIGS. 7A through 7D according to another embodiment of the present invention. Referring to FIG. 14, ENAV unit #2 corresponds to PTS 10000-19999 or logical block 10000-19999 of DVD-Video and ENAV unit #3 corresponds to PTS 20000-N or logical block 20000-N. ENAV unit #2 has at least one ENAV page, and the ENAV page comprises a start page 71 and the remaining ENAV pages 81. ENAV unit #3 also has at least one ENAV page, and the ENAV page comprises a start page 72 and the remaining ENAV pages 82. The start page 71 of ENAV unit #2 has a predetermined proper name, and the start file name #2 and the start page 72 of ENAV unit #3 has a predetermined proper name and start file name #3. Accordingly, if a file having a predetermined proper name is called, the presentation engine 6 can realize that an ENAV unit change has been made. As an ENAV unit is changed, the ENAV buffer manager 61 can send a control command commanding that the ENAV-unit buffer 42 be emptied and that a new ENAV unit be read in. If there are a plurality of start pages in an ENAV unit, only a start page which indicates that an ENAV change will occur is made to have a predetermined proper name.

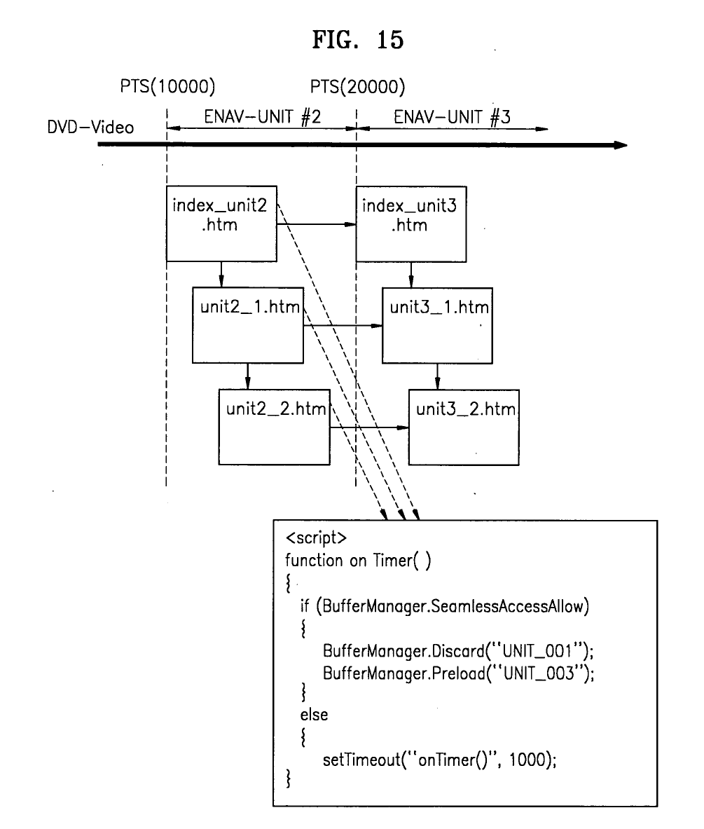

FIG. 15 shows a buffer control method of FIG. 6 according to yet another embodiment of the present invention. Referring to FIG. 15, ENAV unit #2 corresponds to a PTS 10000-19999 of DVD-Video or a logic block 10000-19999 of DVD-Video, and ENAV unit #3 corresponds to PTS 20000-N or a logic block 20000-N. ENAV unit #2 has markup documents index_unit2.htm, unit2_{—}1.htm and unit2_{—}2.htm corresponding to ENAV pages. ENAV unit #3 has markup documents index_unit3.htm, unit3_{—}1.htm and unit3_{—}2.htm corresponding to ENAV pages. Here, arrows having dotted lines indicate routes through which the user can navigate.

In the shown embodiment, the ENAV-unit buffer 42 is practically managed by the intention of the producer. That is, the producer inserts control command information for directly controlling the ENAV-unit buffer 42 in all ENAV pages where an ENAV unit can be changed. For example, in the box marked by dotted lines in the ENAV page of ENAV unit #3 of FIG. 10, control command information for the ENAV-unit buffer 42 is recorded as follows:

navigator.Discard(“ENAV_Unit_Buffer1”).

The presentation engine 6 can realize the control command information only after parsing the called markup document. Based on the realized information, the ENAV buffer manager 61 sends a corresponding control command such that the ENAV-unit buffer 42 is controlled. In the shown embodiment, the presentation engine 6 only needs to support control commands such as navigator.Discard(“ENAV_Unit_Buffer1”). When the interactive data is produced so that one ENAV unit is reproduced and then a navigation route is set to the next ENAV unit, the producer should insert the control command information. By doing so, seamless reproduction can be guaranteed by emptying a designated buffer 421 and 422 and reading a next ENAV unit into the buffer in advance before AV data corresponding to the ENAV data is reproduced.

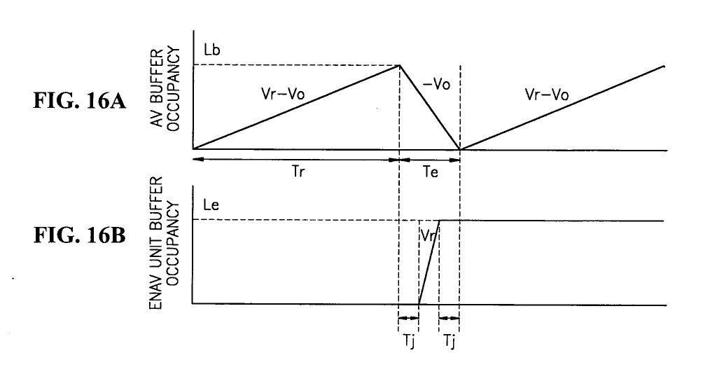

FIGS. 16A and 16B illustrate the amount of AV data read so as to read an ENAV unit and a size of an AV buffer for buffering the AV data. More specifically, FIGS. 16A and 16B illustrate a time Te required to read an ENAV unit when a decoding speed of the AV data is Vo and a reading speed of data from a disc is Vr. Assuming that Tj is a time required to move a pickup on a disc to a position of an ENAV unit, and Le is a size of an ENAV unit, the time Te required to read the ENAV unit can be calculated using Equation 1 as follows:

Te=2×Tj+Le/Vr (1)

Also, since the ENAV unit must be read before exhausting all of the AV data Lb stored in an AV buffer, the following Equation 2 must be satisfied. If the amount Lb of the AV data stored in the AV buffer 3 is larger than the size Le of the ENAV unit, the ENAV unit can be continuously supplied to the AV reproducing engine 5 while reading the ENAV unit.

Te<Lb/Vo (2)

Also, to store the amount Lb of the AV data is stored in the AV buffer 3, at least a number Lr of AV data blocks must be read as set forth in Equation 3.

Lb<(Vr−Vo)×(Lr/Vr)

Lr>(Lb×Vr)×(Vr−Vo) (3)

If Lb>Te×Vo inferred from Equation 2 is applied to Equation 3, the following Equation 4 is obtained:

Lr>(Te×Vo×Vr)/(Vr−Vo) (4)

If Te of Equation 1 is applied to Equation 4, the following Equation 5 is obtained:

Lr>((2×Tj+Le/Vr)×Vo×Vr)/(Vr−Vo) (5)

If Tj, Lei, Vr, and Vo have fixed values, a minimum value of Lr can be calculated.

The time Tr required to read the number Lr of AV data blocks is calculated as follows using Equation 6:

Tr=Lr/Vr (6)

Assuming that Vr, Vo, Le, and Tj have fixed values, Te, Lb, Lr, and Tr are calculated using the above equations, as follows:

| | |
|---|---|
| Vr | 22.16 Mbps (=22,160,000 bps) |
| Vo | 10.08 Mbps (=10,080,000 bps) |
| Le | 2 Mbytes (=16,777,216 bits) |
| Tj | 1,000 msec |
| Te | 1,000 msec × 2 + 758 msec = 2,758 msec |
| Lb | 2,758 × 10,080 = 27,800,640 bits |
| Lr | 50,998,526 bits => 3113 blocks (=194 ECC blocks) |
| Tr | 2,995 msec (it is calculated using ECC blocks) |

Here, it is assumed that 1 block is 2048 bytes and 16 blocks make up an ECC block. Accordingly, the minimum amount of AV data read to read an ENAV unit and a next ENAV unit is 194 ECC blocks (i.e., 6.2 Mbytes).

As described above, according to aspects of the present invention, when AV data is reproduced in an interactive mode, interactive data is divided into a plurality of ENAV units and stored in advance. Then, when predetermined AV data is reproduced, a buffer is emptied when an ENAV is to be changed, and the ENAV unit to be changed is read in advance. In this manner, the buffer is managed such that seamless reproduction of AV data is guaranteed.

It is understood that, according to an aspect of the invention, the AV reproducing engine 5, and the ENAV buffer manager 61, and/or the blender 7 can be implemented as computer software encoded on a computer readable medium for controlling a general or special purpose computer. It is further understood that the DVD 300 can be recorded on a recordable DVD 300 so as to achieve the methods of FIGS. 7A through 7D. Also, it is understood that other information media may be used instead of the DVD 300, such as CD, DVD-R, DVD-R/W, next generation DVD such as Blu-Ray discs, Advanced Optical Discs, and discs utilizing WINDOWS MEDIA VIDEO, or magnetic media.

Although a few embodiments of the present invention have been shown and described, it would be appreciated by those skilled in the art that changes may be made in this embodiment without departing from the principles and spirits of the invention, the scope of which is defined in the claims and their equivalents.

What is claimed is:

1. An information storage medium for use with a recording and/or reproducing apparatus, the medium comprising:
audio/video (AV) data; and
interactive data to be reproduced with the AV data by the recording and/or reproducing apparatus in an interactive mode,
wherein:
the interactive data comprises a plurality of ENAV units, and
each of the ENAV units corresponds to a portion of the AV data and has a size less than a predetermined size.

2. The information storage medium of claim 1, comprising an area in which the plurality of ENAV units are continuously recorded.

3. The information storage medium of claim 1, wherein:
the interactive data comprises link information specifying a relation between the AV data and the corresponding ENAV units, and
the link information is described using a structure of the AV data.

4. The information storage medium of claim 1, wherein:
the interactive data comprises link information specifying a relation between the AV data and the corresponding ENAV units, and
the link information is described using reproduction time information of the AV data.

5. The information storage medium of claim 1, wherein:
the interactive data comprises link information specifying a relation between the AV data and the corresponding ENAV units, and
the link information is described using reproduction location information of the AV data.

6. The information storage medium of claim 1, wherein each of the ENAV units comprises at least one markup resource.

7. The information storage medium of claim 4, wherein each of the ENAV units comprises:
at least one ENAV page including a markup resource, and
the ENAV page includes synchronization information indicating a time at which to display the ENAV page.

8. The information storage medium of claim 7, wherein the ENAV page comprises a markup document.

9. The information storage medium of claim 8, wherein the markup document comprises a startup file including the link information.

10. The information storage medium of claim 8, wherein the markup document comprises a schedule file including the link information.

11. The information storage medium of claim 8, wherein corresponding synchronization information is recorded in each ENAV page including the markup resource.

12. The information storage medium of claim 11, wherein:
the AV data comprises DVD-Video data having corresponding presentation time stamps, and
the link information and the synchronization information are described using the presentation time stamp of the corresponding DVD-Video data.

13. The information storage medium of claim 11, wherein:
the AV data is DVD-Video data having corresponding logical block locations, and
the link information and the synchronization information are described using logical block location information of the corresponding DVD-Video data.

14. An information storage medium for use with a recording and/or reproducing apparatus, the medium comprising:
audio/video (AV) data; and
interactive data to be reproduced by the recording and/or reproducing apparatus with the AV data in an interactive mode,
wherein:
the interactive data comprises a plurality of ENAV units,
each of the ENAV units is smaller than a predetermined size, and
each ENAV unit includes a start page stored with a predetermined start file name recognized by the recording and/or reproducing apparatus to associate and/or control the buffering of the ENAV unit with the corresponding AV data during the interactive mode.

15. The information storage medium of claim 14, wherein each of the ENAV units comprises:
at least one ENAV page, and
the start page is one of the ENAV pages.

16. The information storage medium of claim 14, wherein the interactive data comprises a markup document and markup resources linked to the markup document.

17. The information storage medium of claim 14, wherein the AV data comprises DVD-Video data.

18. An information storage medium for use with a recording and/or reproducing apparatus, the medium comprising:
audio/video (AV) data; and
interactive data to be reproduced by the recording and/or reproducing apparatus with the AV data in an interactive mode,
wherein:
the interactive data comprises a plurality of ENAV units,
each of the ENAV units is smaller than a predetermined size, and
each ENAV unit includes a start page stored with a predetermined directory file name recognized by the recording and/or reproducing apparatus to associate and/or control the buffering of the ENAV unit with the corresponding AV data during the interactive mode.

19. An information storage medium for use with a recording and/or reproducing apparatus, the medium storing:
audio/video (AV) data; and
interactive data for use by the recording and/or reproducing apparatus for reproducing the AV data in an interactive mode,
wherein:
the interactive data includes at least one ENAV page, and
at least one of the ENAV pages includes control command information for an ENAV buffer which the recording and/or reproducing apparatus uses to buffer the ENAV page.

20. The information storage medium of claim 19, wherein the control command information commands existing data stored in the ENAV buffer to be discarded.

21. The information storage medium of claim 19, wherein:
the interactive data is divided into a plurality of ENAV units, and
each of the ENAV units includes a corresponding one of the ENAV pages.

22. The information storage medium of claim 21, wherein the control command information commands a buffered ENAV unit stored in the ENAV buffer to be discarded and another ENAV unit to be read into the ENAV buffer.

23. An apparatus for recording and/or reproducing audio/video (AV) data in an interactive mode, comprising:
an ENAV buffer which buffers interactive data for reproducing the AV data in the interactive mode, where the interactive data is divided into a plurality of ENAV units and each of the ENAV units has a size that is less than a predetermined size;
an ENAV buffer manager which controls the ENAV buffer so that the interactive data is read in and discarded in one or more units of the ENAV units; and
a reproducing unit that reproduces the AV data in the interactive mode using the interactive data from the ENAV buffer.

24. The apparatus of claim 23, wherein the ENAV buffer comprises a plurality of ENAV unit buffers, and a size of each of the ENAV unit buffers is at or greater than the predetermined size of each of the ENAV units.

25. The apparatus of claim 23, wherein the ENAV buffer manager
refers to the interactive data to detect link information between the AV data and the ENAV units and which is described using a structure of the AV data, and
controls the ENAV buffer using the detected link information so that an ENAV unit is read in before a display of a portion of the AV data that corresponds to the ENAV unit.

26. The apparatus of claim 23, wherein the ENAV buffer manager:
refers to the interactive data to detect link information between the AV data and the ENAV units and which is described using a reproduction time information of the AV data, and
controls the ENAV buffer using the detected reproduction time information so that an ENAV unit is read in before a display of a portion of the AV data that corresponds to the ENAV unit.

27. The apparatus of claim 23, wherein the ENAV buffer manager:
refers to the interactive data to detect synchronization information recorded in a markup document for each ENAV page in a corresponding ENAV unit, and
controls the ENAV buffer using the detected synchronization information so that an ENAV unit corresponding to the synchronization information is read into the ENAV buffer.

28. The apparatus of claim 27, wherein the ENAV buffer manager further refers to link information between the AV data and the ENAV units to control the ENAV buffer so that the corresponding ENAV unit is read into the ENAV buffer.

29. The apparatus of claim 28, wherein:
the interactive data includes a markup document and markup resources linked to the markup document,
the markup document includes a startup file in which the link information is recorded, and
the synchronization information is recorded in the markup document corresponding to each ENAV page.

30. The apparatus of claim 28, wherein:
the AV data is DVD-Video data having corresponding presentation time stamps, and
the link information and the synchronization information are described by using a corresponding presentation time stamp of the DVD-Video data.

31. The apparatus of claim 28, wherein:
the AV data is DVD-Video data having corresponding logical blocks, and
the link information and the synchronization information are described using corresponding logical block information of the DVD-Video data.

32. An apparatus for reproducing audio/video (AV) data in an interactive mode, comprising:
an ENAV buffer which buffers interactive data for reproducing the AV data in the interactive mode, where the interactive data is divided into a plurality of ENAV units, and each of the ENAV units is smaller than a predetermined size;
an ENAV buffer manager which controls the ENAV buffer so that, if a start page having a predetermined file name is found, a corresponding one of the ENAV units is read into the ENAV buffer; and
a reproducing unit that reproduces the AV data in the interactive mode using the interactive data from the ENAV buffer.

33. An apparatus for reproducing audio/video (AV) data in an interactive mode, comprising:
an ENAV buffer which buffers interactive data for reproducing the AV data in the interactive mode, where the interactive data is divided into a plurality of ENAV units, and each of the ENAV units is smaller than a predetermined size;
an ENAV buffer manager which controls the ENAV buffer so that a corresponding one of the ENAV units is read into the ENAV buffer when a directory with a predetermined name is detected; and
a reproducing unit that reproduces the AV data in the interactive mode using the interactive data from the ENAV buffer.

34. The apparatus of claim 32, wherein the ENAV unit has at least one ENAV page and the start page is one of the ENAV pages.

35. The apparatus of claim 32, wherein the interactive data includes a markup document and markup resources linked to the markup document.

36. A method of reproducing audio/video (AV) data in an interactive mode comprising:
buffering interactive data for reproducing in the interactive mode the AV data by reading in and discarding the interactive data in one or more units of the ENAV units, wherein each of the ENAV units is smaller than a predetermined size; and
reproducing the AV data in the interactive mode using the buffered interactive data.

37. The method of claim 36, wherein:
the buffering the interactive data comprises reading one of the ENAV units before a display of a unit of the AV data corresponding to the read one ENAV unit by referring to link information between the AV data and the ENAV units, and
the link information is described by using a structure of the AV data.

38. The method of claim 36, wherein:
the buffering the interactive data comprises reading one of the ENAV units before a display of a unit of the AV data corresponding to the one ENAV unit by referring to link information between the AV data and the ENAV units, and
the link information is described using a reproduction time information of the AV data.

39. The method of claim 36, wherein:
each of the ENAV pages includes a markup document including synchronization information, and
the buffering the interactive data comprises reading one of the ENAV units corresponding to the synchronization information by referring to the synchronization information recorded in the markup document of the ENAV page corresponding to the ENAV unit.

40. The method of claim 39, wherein the buffering the interactive data further comprises reading the corresponding one ENAV unit by referring to link information between the AV data and the ENAV units.

41. The method of claim 40, wherein:
the interactive data comprises a markup document and markup resources linked to the markup document,
the markup document comprises a startup file in which the link information is recorded, and
the synchronization information is recorded in the markup document corresponding to each ENAV page.

42. The method of claim 41, wherein:
the AV data is DVD-Video data having corresponding presentation time stamps, and
the link information and the synchronization information are described using the corresponding presentation time stamp of the DVD-Video data.

43. The method of claim 41, wherein:
the AV data is DVD-Video data having corresponding logical blocks, and
the link information and the synchronization information are described using logical block information of the DVD-Video data.

44. The information storage medium of claim 1, wherein:
an amount Lr of the AV data read for each corresponding ENAV unit to be read is Lr>((2×Tj+Le/Vr)×Vo×Vr)/(Vr−Vo),
Tj denotes a time required to read the corresponding ENAV unit by a pickup of the recording and/or reproducing apparatus,
Le denotes the size of an ENAV unit,
Vr denotes a speed with which the AV data is read from the information storage medium, and
Vo denotes a decoding speed with which the read AV data is decoded.

45. The apparatus of claim 23, wherein:
an amount Lr of the AV data read for each corresponding ENAV unit to be read is Lr>((2×Tj+Le/Vr)×Vo×Vr)/(Vr−Vo),
Tj denotes a time required to read the corresponding ENAV unit by a pickup of the apparatus,
Le denotes the size of the corresponding ENAV unit,
Vr denotes a speed with which the AV data is read from an information storage medium, and
Vo denotes a decoding speed with which the read AV data is decoded.

46. The method of claim 36, wherein:
an amount Lr of the AV data read for each corresponding ENAV unit to be read is Lr>((2×Tj+Le/Vr)×Vo×Vr)/(Vr−Vo),
Tj denotes a time required to read the corresponding ENAV unit by a pickup from a disc,
Le denotes a size of the corresponding ENAV unit,
Vr denotes a speed with which the AV data is read from the disc, and
Vo denotes a decoding speed with which the read AV data is decoded.

47. A recording and/or reproducing apparatus for reproducing first data in an interactive mode, comprising:
a buffer which buffers units of interactive data for reproducing corresponding portions of the first data in the interactive mode;
a buffer manager which controls the buffer so that a corresponding one of the units is read into the buffer; and
a reproducing unit that reproduces the first data in the interactive mode using the interactive data from the buffer,
wherein the reproducing unit and the buffer manager control the reproduction and buffering such that:
an amount Lr of the first data read by the recording and/or reproducing apparatus for each corresponding unit to be read by the recording and/or reproducing apparatus is Lr>((2×Tj+Le/Vr)×Vo×Vr)/(Vr−Vo),
Tj denotes a time required to read the corresponding unit into the recording and/or reproducing apparatus,
Le denotes a size of the corresponding unit,
Vr denotes a speed with which the first data is read by the recording and/or reproducing apparatus, and
Vo denotes a decoding speed with which the read first data is decoded by the reproducing unit.

48. The recording and/or reproducing apparatus of claim 47, wherein:
the first data is organized in a first directory,
the interactive data is organized in an interactive directory other than the first directory,
the interactive directory includes folders in which corresponding units of the interactive data are organized, and
the recording and/or reproducing apparatus detects one of the folders having a predetermined name, and buffers a corresponding unit of the interactive data from the detected folder having the predetermined name.

49. The recording and/or reproducing apparatus of claim 48, wherein the recording and/or reproducing apparatus detects a command from a file in the detected folder, and the buffer manager is controlled by the detected command to buffer the corresponding unit from the folder before the corresponding portion of the first data is read by the recording and/or reproducing apparatus.

50. The recording and/or reproducing apparatus of claim 47, wherein:
the first data is organized in a first directory,
the interactive data is organized in an interactive directory other than the first directory,
the interactive directory includes folders in which the units of the interactive directory are organized,
the recording and/or reproducing apparatus is referred to one of the folders in the interactive directory during reproduction of the first data in the interactive mode, and detects a command from a file in the referenced folder, and
the buffer manager is controlled by the detected command to buffer the corresponding unit from the folder before the corresponding portion of the first data is read.

51. The recording and/or reproducing apparatus of claim 50, wherein the file further includes a command to delete one of the units stored in the buffer in which the corresponding unit is to be preloaded.

52. The recording and/or reproducing apparatus of claim 47, wherein the first data is organized in a VIDEO_TS directory, the interactive data is organized in a DVD_ENAV directory other than the VIDEO_TS directory, and each unit of the interactive data is organized in a corresponding folder of the DVD_ENAV directory.

53. The recording and/or reproducing apparatus of claim 52, wherein the DVD_ENAV directory includes a markup document which includes link information which associates the folders with the first data in the VIDEO_TS so as to allow the portion of the reproduced first data to be reproduced with a corresponding unit of the interactive data read from the corresponding folder.

54. The recording and/or reproducing apparatus of claim 47, wherein the first data and the interactive data read by the recording and/or reproducing apparatus are stored on a storage medium, the first data is stored in a first area of the storage medium, and the interactive data is stored in a second area of the storage medium other than the first area.

55. A recording and/or reproducing apparatus for reproducing first data in an interactive mode, comprising:
a buffer which buffers units of interactive data for reproducing corresponding portions of the first data in the interactive mode;
a buffer manager which controls the buffer so that a corresponding one of the units is read into the buffer; and
a reproducing unit that reproduces the first data in the interactive mode using the interactive data from the buffer,
wherein the first data is organized in a first directory, and the interactive data is organized in an interactive directory logically separated from the first directory.

56. The recording and/or reproducing apparatus of claim 55, wherein:
the interactive directory includes folders in which corresponding units of the interactive data are organized, and
the recording and/or reproducing apparatus detects a folder having a predetermined name, and buffers a corresponding unit of the interactive data from the detected folder having the predetermined name.

57. The recording and/or reproducing apparatus of claim 56, wherein the recording and/or reproducing apparatus detects a command from a file in the detected folder, and the buffer manager is controlled by the detected command to buffer the corresponding unit from the folder before the corresponding portion of the first data is read.

58. The recording and/or reproducing apparatus of claim 55, wherein:
the interactive directory includes folders in which the units of the interactive directory are organized,
the recording and/or reproducing apparatus is referred to one of the folders in the interactive directory during reproduction of the first data in the interactive mode, and detects a command from a file in the referenced folder, and
the buffer manager is controlled by the detected command to buffer the corresponding unit from the folder before the corresponding portion of the first data is read.

59. The recording and/or reproducing apparatus of claim 58, wherein the file further includes a command to delete one of the units stored in the buffer in which the corresponding unit is to be preloaded.

60. The recording and/or reproducing apparatus of claim 55, wherein the first directory comprises a VIDEO_TS directory, the interactive directory is a DVD_ENAV directory having folders, and each unit of the interactive data is organized in a corresponding folder of the DVD_ENAV directory.

61. The recording and/or reproducing apparatus of claim 60, wherein the DVD_ENAV directory includes a markup document which includes link information which associates the folders with the first data in the VIDEO_TS so as to allow the portion of the reproduced first data to be reproduced with a corresponding unit of the interactive data read from the corresponding folder.

62. The recording and/or reproducing apparatus of claim 55, wherein the first data and the interactive data read by the recording and/or reproducing apparatus are stored on a storage medium, the first data is stored in a first area of the storage medium, and the interactive data is stored in a second area of the storage medium other than the first area.

63. An information storage medium for use with a recording and/or reproducing apparatus, the medium comprising:
first data in a first area of the information storage medium and organized in a first directory; and
interactive data in an interactive area of the information storage medium other than the first area and organized in an interactive directory,
wherein:
the interactive data comprises a plurality of units,
each of the units corresponds to a portion of the first data,
the interactive directory includes folders in which corresponding units of the interactive data are organized, and
the recording and/or reproducing apparatus is referred to one of the folders and buffers a corresponding unit of the interactive data from the referenced folder into a buffer to be reproduced by the recording and/or reproducing apparatus with the first data in an interactive mode.

64. The information storage medium of claim 63, wherein the referenced folder has a predetermined name which is recognized by the recording and/or reproducing apparatus as referring to a corresponding one of the folders having the unit to be buffered.

65. The information storage medium of claim 64, wherein the referenced folder has a file including a command, and a buffer manager of the recording and/or reproducing apparatus is controlled by the command to buffer the corresponding unit from the folder before the corresponding portion of the first data is read.

66. The information storage medium of claim 63, wherein at least one of the folders includes a command such that, when the recording and/or reproducing apparatus is referred to the at least one of the folders in the interactive directory during reproduction of the first data in the interactive mode and detects a command from a file in the referenced folder, a buffer manager is controlled by the detected command to buffer the corresponding unit from the at least one folder before the corresponding portion of the first data is read.

67. The information storage medium of claim 66, wherein the file further includes a command to delete one of the units stored in the buffer in which the corresponding unit is to be preloaded.

68. The information storage medium of claim 63, wherein the first directory comprises a VIDEO_TS directory, the interactive directory is a DVD_ENAV directory having folders, and each unit of the interactive data is organized in a corresponding folder of the DVD_ENAV directory.

69. The information storage medium of claim 68, wherein the DVD_ENAV directory includes a markup document which includes link information which associates the folders with the first data in the VIDEO_TS so as to allow the portion of the reproduced first data to be reproduced with a corresponding unit of the interactive data read from the corresponding folder.
